(19) United States
(12) Patent Application Publication
(10) Pub. No.: US 2022/0144673 A1
(43) Pub. Date: May 12, 2022

(54) ELECTRODIALYZER AND ELECTRODIALYSIS SYSTEM FOR CO2 CAPTURE FROM OCEAN WATER

(71) Applicant: California Institute of Technology, Pasadena, CA (US)

(72) Inventors: Chengxiang Xiang, San Marino, CA (US); Harry A. Atwater, South Pasadena, CA (US); Ibadillah A. Digdaya, Los Angeles, CA (US)

(21) Appl. No.: 17/522,241

(22) Filed: Nov. 9, 2021

Related U.S. Application Data
(60) Provisional application No. 63/111,193, filed on Nov. 9, 2020.

(51) Int. Cl. C02F 1/469; C02F 1/461

(52) U.S. Cl. CPC C02F 1/4693; C02F 2101/10; C02F 1/46109

(57) ABSTRACT

Disclosed are electrochemical systems that include an electrodialyzer and a vapor-fed CO₂ reduction (CO₂R) cell to capture and convert CO₂ from ocean water. The electrodialyzer includes a stack of bipolar membrane electrodialysis (BPMED) cells between end electrodes. The electrodialzyer incorporates monovalent cation exchange membranes (M-CEMs) that prevent the transfer of multivalent cations between adjacent cell compartments, allowing continuous recirculation of electrolytes and solutions, and thus providing a safer and more scaling-free electrodialysis system. In some embodiments, the electrodialyzer may be configured to replace the water-splitting reaction at end electrodes with one-electron, reversible redox couples in solution at the electrodes. As a result, in the entire electrodialyzer stack, there is no bond-making, bond-breaking reactions and there is no gas generation, which significantly simplifies the cell design and improves operational safety. The systems provide a unique technological pathway for CO₂ capture and conversion from ocean water with only electrochemical processes.

### CROSS REFERENCE TO RELATED APPLICATIONS

This Application claims the benefit of U.S. Provisional Patent Application Ser. No. 63/111,193, filed on Nov. 9, 2020, which is incorporated by reference herein in its entirety.

### STATEMENT REGARDING GOVERNMENTAL SUPPORT

This invention was made with government support under Grant No. DE-SC004993 awarded by the Department of Energy. The government has certain rights in the invention.

### TECHNICAL FIELD

The present disclosure generally relates to electrodialysis, and more particularly, to industrial-scale electrodialyzers suitable for treating ocean water.

### BACKGROUND

The capture and conversion of CO₂ from anthropogenic emission is becoming an increasingly important social responsibility as the concentration of atmospheric CO₂ continues to rise to record high levels. Carbon dioxide from the atmosphere, ocean water and point sources such as coal fired power plants or cement plants is considered as the major feedstock for subsequent capture and conversion processes. The concentration of the present CO₂ in the atmosphere is currently about 400 ppm, or 0.00079 kg m⁻³. As a result, a large volume of air needs to be processed in direct air capture processes. In contrast, the world's oceans constitute the largest carbon sink, absorbing about 40% of anthropogenic CO₂ since the beginning of the industrial era with an effective CO₂ concentration of 2.1 mmol kg⁻¹, or 0.095 kg m⁻³ in seawater, which is a factor of 120 times larger than in the atmosphere. Thus, extraction of CO₂ from seawater provides an alternative approach in the global carbon removal technological landscape relative to direct air capture (DAC).

The operating principle for ocean water capture of CO₂ is to push the CO₂/bicarbonate equilibrium toward dissolved CO₂ by acidifying the ocean water via electrodialysis. The acidified stream is then passed through a liquid-gas membrane contactor, which captures the gaseous CO₂ from the dissolved CO₂ in the aqueous stream. One of the elements in the CO₂ capture system is an electrodialyzer that produces acid and base to produce pH swings in the seawater.

However, known electrodialyzers are generally optimized for other applications such as desalination, and also have certain limitations concerning safety, gas management and stream pre-treatment that make them undesirable for large-scale removal of CO₂ from ocean water. Accordingly, an improved electrodialyzer is needed for emerging applications, such as CO₂ capture and conversion from seawater.

### SUMMARY

Disclosed herein are examples of one or more inventive electrodialyzers that are suitable for industrial scale capture and conversion of CO₂ from ocean water. These electrodialyzers overcome at least some of the limitations associated with known electrodialyzers.

For example, challenges and limitations associated with existing electrodialyzers include:
a) the use of water-splitting reactions at the end electrodes, which increases the total voltage for the electrodialyzer and presents additional design challenges for gas management and safety concerns.
b) pre-treatment of ocean water is required to remove Ca²⁺ and Mg²⁺ ions, which can form precipitates upon reaction with hydroxides in the base compartment of the electrodialyzer and may lead to scaling and fouling in the membrane system. Nano-filtration (NF) using organic, thin-film composite membranes with a pore size range of 0.1 to 10 nm have been used to remove the divalent cations from ocean water, but the process requires significant energy inputs due to high pressure needed in the operation.
c) Some existing electrodialyzer are designed and optimized for generation of acid and base (without salt) or for generation of desalinized ocean water for subsequent processes. The acidification and basification of ocean water have very different requirements than those applications.

The electrodialysis systems disclosed herein overcome the aforementioned limitations by using novel configurations of electrodialyzer stacks.

In accordance with an exemplary embodiment, an electrodialyzer includes a cell stack having one or more multi-compartment cells. Each of the cells includes: a saltwater compartment, a base compartment receiving a base stream, and a bipolar membrane (BPM) separating the saltwater compartment and base compartment. The electrodialyzer further includes: a catholyte compartment, a first monovalent cation exchange membrane (M-CEM) separating the catholyte compartment and the saltwater compartment of one of the multi-compartment cells, a cathode contacting the catholyte compartment, an anolyte compartment, a second M-CEM separating the anolyte compartment and the base compartment of one of the multi-compartment cells, an anode contacting the anolyte compartment, and one or more intermediate M-CEMs separating the multi-compartment cells, if there is more than one multi-compartment cell in the electrodialyzer.

In accordance with another exemplary embodiment, an electrodialyzer includes a cell stack having one or more multi-compartment cells. Each of the cells includes: a first compartment, a second compartment, an anion exchange membrane (AEM) separating the first compartment and the second compartment, a third compartment, and a bipolar membrane (BPM) separating the second compartment and the third compartment. The electrodialyzer further includes: a catholyte compartment, a first monovalent cation exchange membrane (M-CEM) separating the catholyte compartment and the first compartment of one of the multi-compartment cells, a cathode contacting the catholyte compartment, an anolyte compartment, a second M-CEM separating the anolyte compartment and the third compartment of one of the multi-compartment cells, an anode contacting the anolyte compartment, and one or more intermediate monovalent cation exchange membranes (M-CEMs) separating the multi-compartment cells, if there is more than one multi-compartment cell in the electrodialyzer.

The foregoing summary does not define the limits of the appended claims. Other aspects, embodiments, features, and advantages will be or will become apparent to one with skill in the art upon examination of the following figures and detailed description. It is intended that all such additional features, embodiments, aspects, and advantages be included within this description and be protected by the accompanying claims.

### BRIEF DESCRIPTION OF THE FIGURES

It is to be understood that the drawings are solely for purpose of illustration and do not define the limits of the appended claims. Furthermore, the components in the figures are not necessarily to scale. In the figures, like reference numerals designate corresponding parts throughout the different views.

FIG. 1 is a schematic illustration of a first exemplary electrodialyzer that may be used for capturing CO₂ from ocean water.

FIG. 2 is a schematic illustration of an exemplary electrodialysis system for capturing CO₂ from ocean water, which system uses the electrodialyzer of FIG. 1.

FIG. 3 is a schematic illustration of a second exemplary electrodialyzer that may be used for capturing CO₂ from ocean water.

FIG. 4 is a schematic illustration of a third exemplary electrodialyzer that may be used for capturing CO₂ from ocean water.

FIG. 5 is a schematic illustration of a fourth exemplary electrodialyzer that may be used for capturing CO₂ from ocean water.

FIG. 6 is a schematic illustration of a second exemplary electrodialysis system for capturing CO₂ from ocean water, which system uses the electrodialyzer of FIG. 5.

### DETAILED DESCRIPTION

The following detailed description, which references to and incorporates the drawings, describes and illustrates one or more examples of systems, devices, and methods of electrodialysis. These examples, offered not to limit but only to exemplify and teach embodiments of inventive systems, apparatuses and methods, are shown and described in sufficient detail to enable those skilled in the art to practice what is claimed. Thus, where appropriate to avoid obscuring the invention, the description may omit certain information known to those of skill in the art. The disclosures herein are examples that should not be read to unduly limit the scope of any patent claims that may eventual be granted based on this application.

The word “exemplary” is used throughout this application to mean “serving as an example, instance, or illustration.” Any system, method, device, technique, feature or the like described herein as “exemplary” is not necessarily to be construed as preferred or advantageous over other features.

As used in this specification and the appended claims, the singular forms “a,” “an,” and “the” may include plural referents unless the content clearly dictates otherwise.

Although any methods and materials similar or equivalent to those described herein can be used in the practice or testing of the invention(s), specific examples of appropriate materials and methods are described herein.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Disclosed herein are several examples electrodialysis cell stacks that include features that allow the operation of oceanic CO₂ capture to be more efficient and cost effective.

For example, in some of the disclosed cell stacks, at the end electrodes, instead of a water-splitting reaction, one-electron, reversible redox couple electrolytes may be used to facilitate the reaction, and as a result, in the entire electrodialyzer stack, there is no bond-making, bond-breaking reactions, and thus, there is no gas generation, which significantly simplifies the cell design and lowers the safety requirements.

Additionally, each of the disclosed embodiments of the electrodialyzer incorporate monovalent cation exchange membranes (M-CEMs) that prevent the transfer of multivalent cations to adjacent cell compartments, allowing continuous recirculation of electrolytes and base solution streams, and thus, allow for safe and largely scale-free electrodialysis systems.

Furthermore, the disclosed electrodialyzers allow the cost-effective production of acid and base in salt solution, instead of pure acid or base, which significantly relaxes the membrane requirements for ion crossovers.

The disclosed electrodialyzers may be advantageously used for ocean water CO₂ capture, where the inventive electrodialysis membrane systems may each remain largely free of mineral scaling during operation. In this application, the disclosed electrodialyzers provide further advantage in that they each allow the supporting chemicals to be recyclable with pure water as the only input feedstock into the electrodialysis system.

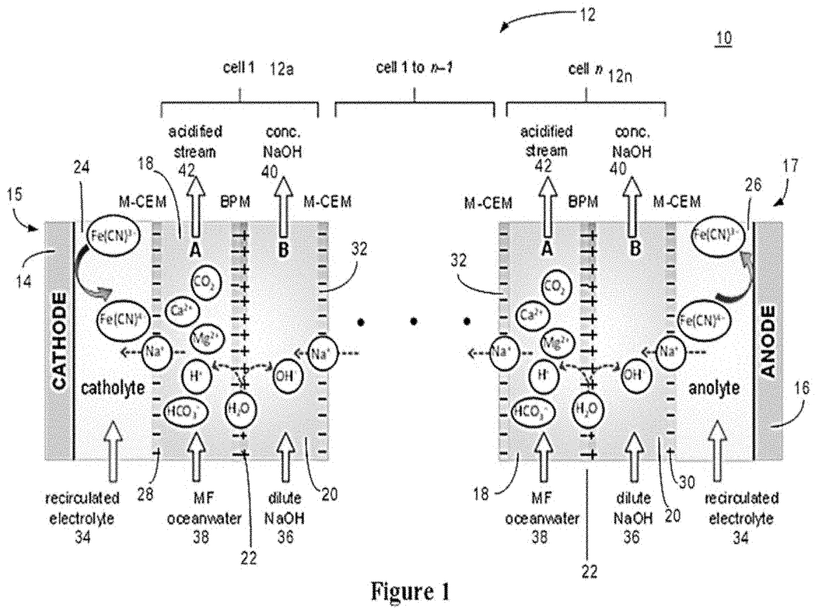

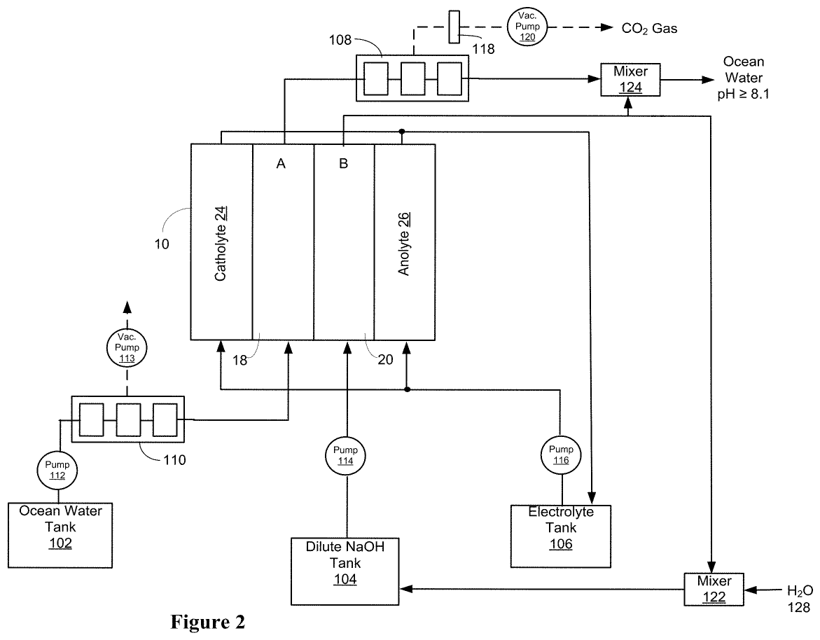

FIG. 1 is a schematic illustration of an exemplary electrodialyzer 10. The electrodialyzer 10 may be used for capturing CO₂ from ocean water, as described more fully below in connection with FIG. 2. Alternatively, the electrodialyzer 10 may be used in other applications, for example, generating acid and base streams or the like.

The electrodialyzer 10 includes a stack having one or more multi-compartment cells 12. Each of the cells 12a, 12n includes a saltwater compartment 18, a base compartment 20 receiving a base stream 36, e.g., a dilute NaOH stream, and a bipolar membrane (BPM) 22 separating the saltwater compartment and base compartment 20. The electrodialyzer 10 further includes two end electrodes 15, 17 at either end of the cell stack 12. At the first end electrode 15, a catholyte compartment is located at a cathode 14 contacting the catholyte compartment 24. A first monovalent cation exchange membrane (M-CEM) 28 separates the catholyte compartment 24 and the saltwater compartment 18 of cell 12a. At the second end electrode 17, an anolyte compartment 26 is located at an anode 16 contacting the anolyte compartment 26. A second M-CEM 30 separates the anolyte compartment 26 and the base compartment 20 of the n^{th} cell 12n. One or more intermediate M-CEMs 32 separate the cells 12 from their adjacent neighboring cells, provided there is more than one cell 12 in the electrodialyzer 10 stack.

Each of the cells 12 in the electrodialyzer 10 is based on a two-compartment configuration having the saltwater compartment 18 (compartment A) and the base compartment 20 (compartment B) that are separated by the BPM 22. The number of cells can be multiplied to any n number of cells by introducing an intermediate M-CEM 32 between adjacent cells. In each cell 12, the BPM 22 separates the microfiltered (MF) ocean water stream 38 received by compartment A 18 from the base (e.g., NaOH) solution stream 36 received by compartment B 20 and generates protons (H⁺) and hydroxides (OH⁻). Gaseous CO₂ is degassed from the acidified output ocean water stream 42 of compartment A 18, as described with reference to FIG. 2. A fraction of concentrated base (e.g., NaOH) from the output stream 40 of compartment B 20 is used to restore the alkalinity of the acidified ocean water stream 42, and another fraction is diluted with pure water before returning it as input 36 to compartment B 20. This is also described more fully in connection with FIG. 2.

The intermediate M-CEM 32 allows the transfer of sodium ions (Na⁺) and other minor monovalent cations only from compartment A 18 to compartment B 20 of adjacent cells, while rejecting the transfer of anions and multivalent cations from compartment A 18 to compartment B 20 in the adjacent cell.

At each end of the cell stack, the first and second M-CEMs 28, 30 are used, respectively, to separate the catholyte 34 and anolyte 24 from the ocean water 38 and the base solution 36, respectively. The electrolyte solution 34 (i.e., catholyte and anolyte) contains a one-electron electrochemically reversible [Fe(CN)₆]^{3-/4-} redox couple (e.g. Na₃/Na₄—[Fe(CN)₆] or K₃/K₄—[Fe(CN)₆]) to eliminate the voltage penalty of undesired electrochemical reaction at the electrodes 15, 17, and is re-circulated during operation.

The electrochemical reactions at the electrodes, ionic transport across the membranes and water dissociation at the BPM interface are illustrated in FIGS. 1, 3 and 4. At the middle of the multi-compartment cell, the BPM generates proton (H⁺) and hydroxide ion (OH⁻) fluxes via water dissociation reactions at the BPM interface that are used to convert the input ocean water into output streams of acidified ocean water 42 and concentrated base solution 40. The electrode solution 34, i.e., catholyte and anolyte, may contain a reversible redox couple solution, potassium ferro/ferricyanide (K₃/K₄[Fe(CN)₆]) or sodium ferro/ferricyanide Na₃/Na₄—[Fe(CN)₆], and is re-circulated to minimize any polarization losses associated with concentration overpotentials at the electrodes. Two M-CEMs 28, 30 are employed to charge balance the acidified or basified streams by selectively transporting monovalent cations from the anolyte or towards the catholyte, respectively. The electrode reactions in the cell are a one electron, reversible redox reaction as the following:

Cathode: [Fe(CN)₆]³⁻+e⁻→[Fe(CN)₆]⁴⁻ (1)

Anode: [Fe(CN)₆]⁴⁻→[Fe(CN)₆]³⁻+e⁻ (2)

One unique advantage of this configuration is that it can be employed and scaled up both in a single stack configuration or a multi-stack configuration without introduction of any unintended chemical reactions or any additional voltage losses.

The ocean water received by the electrodialyzer 10 can be micro-filtered by being sent through multimedia filter (including disc filter and cartridge filter), followed by ultrafiltration. During these two steps, algae, organic particles, sand particles, smaller impurities and other particles are removed.

In operation, a voltage source (not shown) is connected to the anode 26 and cathode 24 to provide a desired electric potential across the electrode ends with suitable current.

In alternative embodiments of the electrodialyzer 10, the base compartment 20 may receive nano-filtered ocean water instead of a base solution.

FIG. 2 is a schematic illustration of an exemplary electrodialysis system 100 for capturing CO₂ from ocean water, which system 100 uses the electrodialyzer 10 of FIG. 1. The system 100 includes a single-cell configuration of the electrodialyzer 10, an ocean water tank 102, a base solution tank 104, an electrolyte tank 106, one or more first liquid-gas membrane contactors 108 for removing CO₂ gas from the acidified ocean water, and one or more second liquid-gas membrane contactors 110 for removing dissolved gases, e.g., O₂ and N₂, from the input ocean water. Other embodiments of the system 100 may include multi-cell configurations of the electrodialyzer 10.

A pump 112 pumps a stream of micro-filtered (MF) ocean water from the ocean water tank 102 through the membrane contactors 110. The membrane contactors 110 remove dissolved gases, e.g., N₂, O₂ and the like, from the incoming MF ocean water. For example, one or more commercially-available membrane contactors connected in series may be used to vacuum strip the dissolved gases. The dissolved gases are removed from the system 100 by vacuum pump 113. From the contactor membranes 110, the MF ocean water stream passes into and through the saltwater compartment 18 of the electrodialyzer 10. The CO₂ gas comes out of solution in the compartment 18 as the ocean water is acidified. The acidified stream output from the compartment 18 is then passed through the second set of membrane contactors 108, where the CO₂ gas is removed from the acidified stream by a vacuum pump 120. The membrane contactors 108 may include one or a series of commercially-available contactors for vacuum stripping the CO₂ gas from the acidified ocean water. A water vapor trap 118 prevents condensate from entering the pump 120. The water vapor trap 118 may be any suitable means for chilling the gas to condense water or other liquids from the CO₂ gas stream. The acidified ocean water stream output from the membrane contactors 108 is then fed into the mixer 124 where it is combined with a fraction of the concentrated base stream so that the pH of the acidified ocean water is raised back to near levels normally found in the ocean.

A mixer 124 mixes the de-gassed acidified ocean water output from the membrane contactor 108 with a fraction of the concentrated base solution output from the base compartment 20 to raise the pH of the acidified ocean water. The ocean water output from the mixer 124 can then be discharged back into the ocean.

The electrolyte tank 106 holds the electrolytic solution that is re-circulated through the catholyte and anolyte compartments 24, 26 of the electrodialyzer 10. A pump 116 circulates the electrolyte through the system 100.

The pumps 112, 114, 116 may be any suitable type of pump for moving the fluids are the desired flow rates and pressures. For example, they may be commercially-available peristaltic or centrifugal fluid pumps.

In an alternative embodiment of the system 100, micro-filtered and nano-filtered ocean water is used instead of the base solution stream. The MF/NF ocean water is fed into the compartment B 20, instead of a base solution. The MF/NF ocean water is filtered to remove particles, substances, and multivalent cations so that essentially only NaCl remains in the MF/NF ocean water stream. The output stream of the compartment B 20 may be mixed with the acidified stream by mixer 124 and a mixed fraction fed back to the input of compartment B after being filtered. In this embodiment, the base solution tank 104, the pure H₂O input stream 128 and the mixer 122 may be omitted.

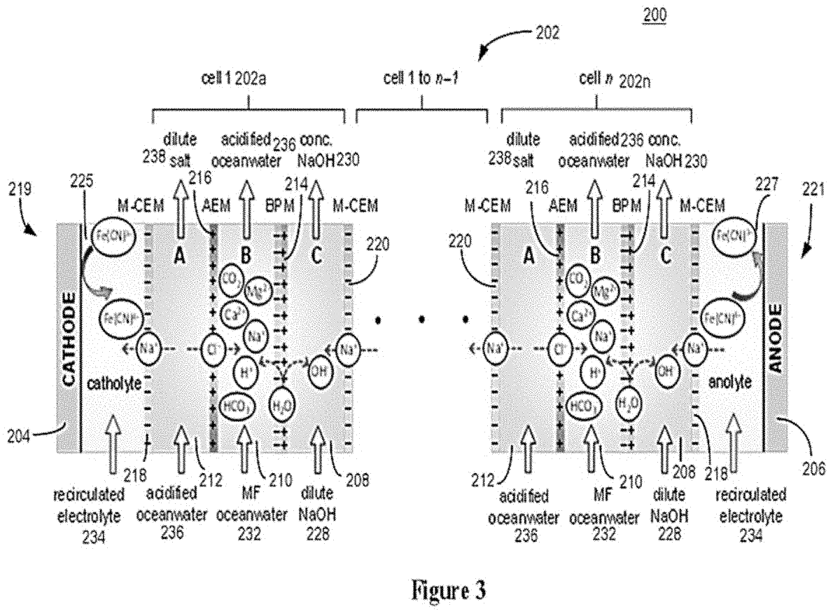

FIG. 3 is a schematic illustration of a second exemplary electrodialyzer 200. The electrodialyzer 200 may be used for capturing CO₂ from ocean water by being incorporated into a system similar to that shown in FIG. 2. Alternatively, the electrodialyzer 200 may be used in other applications, for example, generating acid and base streams or the like.

The electrodialyzer 200 includes a stack having one or more multi-compartment cells 202. Each of the cells 202a, 202n includes a first compartment (compartment A) 212, a second compartment (compartment B) 210, and a third compartment (compartment C) 208. An anion exchange membrane (AEM) 216 separates the first compartment 212 and the second compartment 210, and a bipolar membrane (BPM) 214 separates the second compartment 210 and the third compartment 208. The electrodialyzer 200 further includes end electrodes 219, 221 at either end of the cell stack 202. At the first end electrode 219, a catholyte compartment 225 is located at a cathode 204 contacting the catholyte compartment 225. A first monovalent cation exchange membrane (M-CEM) 218 separates the catholyte compartment 225 and the first compartment 212 of cell 1 202a. At the second end electrode 221, an anolyte compartment 227 is located at an anode 206 contacting the anolyte compartment 227. A second M-CEM 218 separates the anolyte compartment 227 and the third compartment 208 of the n^{th} cell 202n. One or more intermediate M-CEMs 220 separate the cells 202 from their adjacent neighboring cells, provided there is more than one cell 202 in the electrodialyzer 200.

The electrodialyzer 200 incorporates a three-compartment electrodialysis cell 202a which can be multiplied to any suitable n number of cells. In each cell, the AEM 216 separates the acidified ocean water 236 in compartment A 212 from the micro-filtered (MF) ocean water 232 in compartment B 210, and allows the passage of chloride ions (Cl⁻) and other minor anions between compartment A 212 and compartment B 210, while preventing the passage of Na⁺ and other minor cations between the compartments 210, 212. The AEM 216 may be a commercially-available AEM, e.g., FAA-3-50 from FuMA-Tech GmbH, or the like. The BPM 214 is used to separate the MF ocean water 232 in compartment B 210 from the dilute base solution 228 (e.g., NaOH) in compartment C 208 and generates protons (H⁺) and hydroxide ions (OH⁻).

During operation for capturing CO₂ from ocean water, the output stream of acidified ocean water 236 from compartment B 210 is vacuum stripped to directly extract CO₂ from the acidified ocean water 236. This can be accomplished using a system similar to that described in connection with FIG. 2. After de-gassing the CO₂, the acidified ocean water stream 236 is subsequently fed as input to compartment A 212. As described above in connection with FIG. 2, a fraction of the concentrated NaOH base stream 230 from the output stream of compartment C 208 may be used to restore the alkalinity of the acidified ocean water 236 and another fraction of the concentrated base stream 230 is diluted with pure water before sending it back as the diluted base stream 228 input to compartment C 208.

The intermediate M-CEMs 220 are used to separate two adjacent cells from each other and allow the passage of Na⁺ and other minor monovalent cations between cells, while rejecting passage of anions and multivalent cations such as Mg²⁺ and Ca²⁺. At the ends 219, 221 of the cell stack 202, the M-CEMs 218 separate the one-electron redox couple catholyte 234 and anolyte 234 from the acidified ocean water 236 in compartment A 212 and the dilute NaOH 228 in compartment C 208, respectively.

In operation, a voltage source (not shown) is connected to the anode 206 and cathode 204 to provide a desired electric potential across the electrode ends with suitable current.

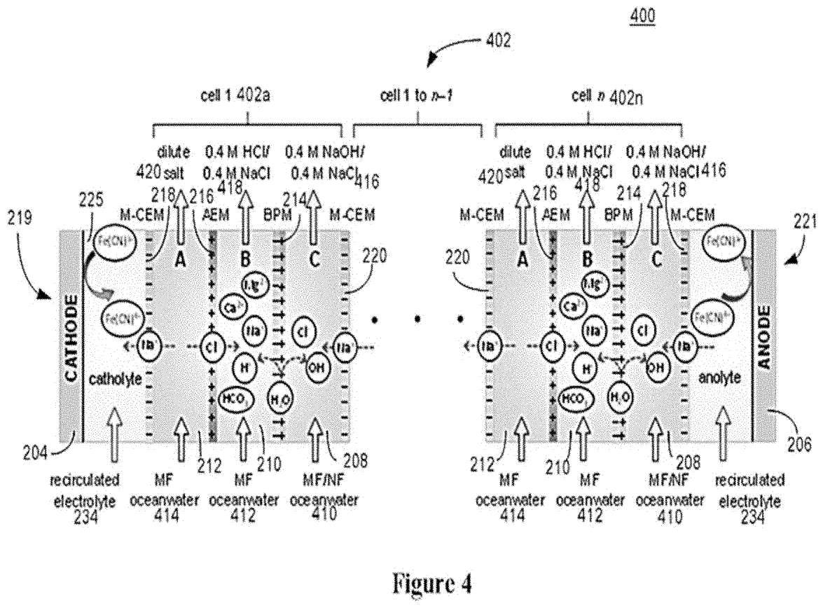

FIG. 4 is a schematic illustration of a third exemplary electrodialyzer 400. The third electrodialyzer 400 is based on the three-compartment cell configuration with the same membrane arrangement as the electrodialyzer 200 of FIG. 3. The number of cells 402 in the electrodialyzer 400 can be multiplied to any suitable n number of cells.

The electrodialyzer 400 may be used for capturing CO₂ from ocean water by being incorporated into a system similar to that shown in FIG. 2. Alternatively, the electrodialyzer 400 may be used in other applications, for example, generating acid and base streams or the like.

In the electrodialyzer 400, only a small fraction of ocean water is used to generate concentrated HCl for acidifying bulk ocean water 418, and to generate concentrated NaOH 416 and dilute salt 420 for restoring the alkalinity of the acidified ocean water 418.

MF ocean water streams 414, 412 comprising all ions are fed to the compartments A and B 212, 210 that are separated with the AEM 216. The AEM 216 allows the passage of anions and rejects the passage of cations between compartments A and B 212, 210. In compartment A 212, cations and anions are pulled away from the input ocean water 414, resulting in a dilute salt water as the output stream 420. Compartment B and C 210, 208 are separated by the BPM 214 that generates protons (H⁺) and hydroxide ions (OH⁻). In compartment B 210, protons are introduced to input MF ocean water 412, forming HCl with the available Cl⁻ in the input ocean water 412, and Cl⁻ ions are transferred from compartment A 212 through the AEM 216 to compartment B 210, forming NaCl with the available Na⁺ in the input ocean water 210.

Prior to entering compartment C 208, the input MF ocean water 410 undergoes a nano-filtration (NF) process to remove multivalent ions. In compartment C 208, hydroxides (OH⁻) are introduced by the BPM 214, forming NaOH with the available Na⁺ in the MF/NF ocean water stream 410, and Na⁺ is transferred from the compartment A 212 of the adjacent cell through an intermediate M-CEM 220, forming NaCl with the available Cl⁻ in the MF/NF ocean water 410 passing through compartment C 208. The intermediate M-CEMs 220 are used to separate each cell from the adjacent cell and allow the passage of Na⁺ and other minor monovalent cations only, while preventing the crossover of the anions and multivalent cations.

At the ends 219, 221 of the cell stack 402, the M-CEMs 218 separate the one-electron redox couple catholyte and anolyte 234 from compartment A 212 and compartment C 208, respectively.

The anodes 16, 206 and cathodes 14, 204 for the electrodialyzers 10, 200, 400 may be any suitable electrical conductor, for example, titanium (Ti) plates with a platinum (Pt) coating.

In some embodiments, the BPMs 22, 214 may be commercially-available bipolar membranes, such as Fumasep bipolar membrane (BPM, from FuMA-Tech GmbH).

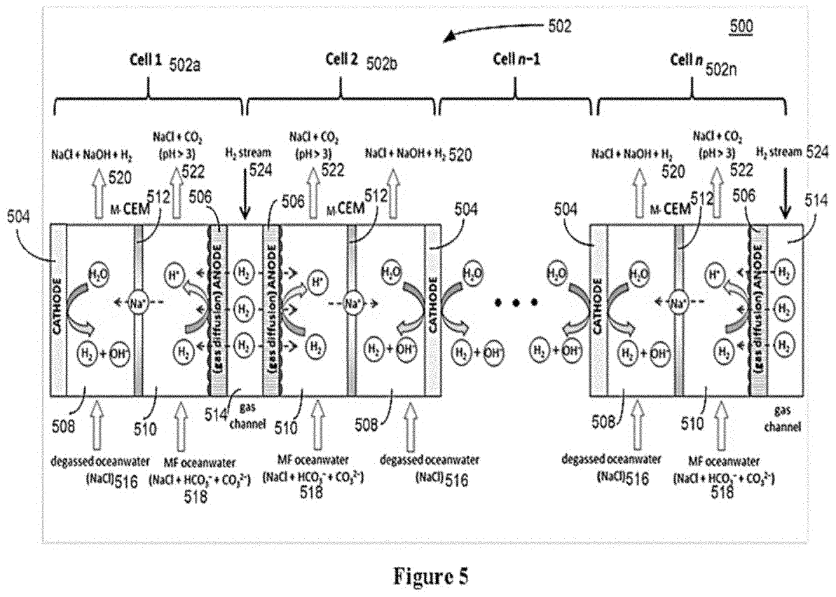

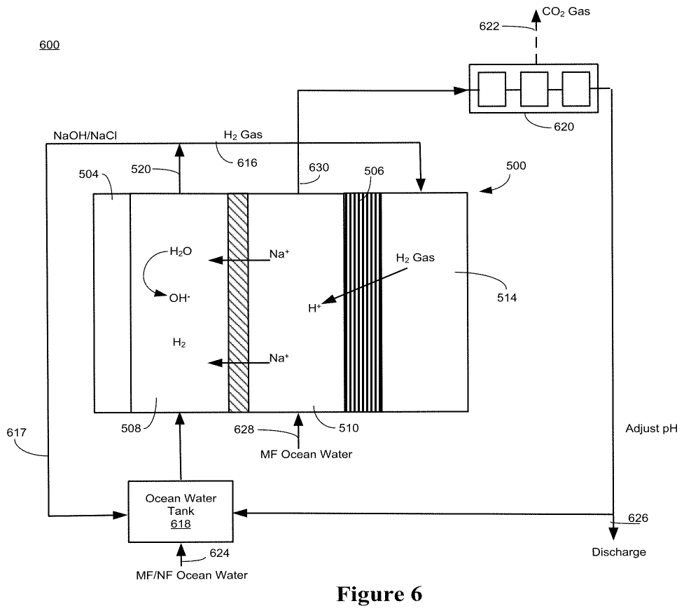

FIG. 5 is a schematic illustration of a fourth exemplary electrodialyzer 500 that may be used for capturing CO₂ from ocean water, as described more fully below in connection with FIG. 6. Alternatively, the electrodialyzer 500 may be used in other applications, for example, generating acid and base streams or the like.

The electrodialyzer 500 includes a stack 502 having one or more multi-compartment cells 502a-502n. The number of cells 502 can be multiplied to any suitable n number of cells.

Each of the cells 502a, 502b, 502n includes a basified compartment 508 for receiving a stream of degassed ocean water 516, an acidified compartment 510 for receiving a stream of MF ocean water 518, an M-CEM 512 separating the basified compartment 508 and acidified compartment 510, a cathode 504, an anode 506, and a gas channel 514 that may be shared with an adjacent cell, if there is one.

In operation, a voltage source (not shown) is connected to the anode(s) 606 and cathode(s) 604 to provide a desired electric potential across the electrode ends with suitable current.

With voltage applied, the cathode 504 performs a water reduction reaction in the degassed ocean water 516 within the basified compartment 508 to produce H₂ (gas) and hydroxide (OH⁻). The cathode materials may include Ni, Fe, Pt, or the like. The cathode 504 can be a planar electrode or micro-structured electrodes.

With the voltage applied, the anode 506 performs an H₂ (gas) oxidation reaction to produce protons H⁺ within the MF ocean water stream 518 passing through the acidified compartment 510. In some embodiments, gas diffusion electrodes are used at the anode 506 for H₂ oxidation, where H₂ gas is fed through the gas channel 514 to react with the H₂ gas oxidation catalysts, such as Pt. The H₂ gas stream 524 fed into the gas channel 514 may come from the basified stream 520 via, for example, vacuum stripping of the basified stream 520.

The M-CEM 512 allows the transfer of sodium ions (Na⁺) and other minor monovalent cations only from the acidified compartment 510 to basified compartment 508, while rejecting the transfer of anions and multivalent cations. The M-CEM 512 transport of Na⁺ and has minimal crossover of H⁺ because of the concentration difference between Na⁺ and H⁺ in pH>3 ocean water.

During operation, ocean water 518 after microfiltration enters the acidified compartment 510, where the conversion of bicarbonate ion (HCO₃⁻) and carbonate ion (CO₃²⁻) to dissolved CO₂ takes place. Upon leaving the acidified compartment, the acidified stream 522 is vacuum stripped in a membrane contactor 620 by a vacuum pump for CO₂ extraction, as shown in FIG. 6.

Also during operation, the degassed ocean water stream 516 with microfiltration and nano-filtration (free of di-cations) enters the basified chamber 508. The removal of di-cations prevent scaling and fouling at the cathode 504 surface.

The basified output stream 520 may then be combined with the acidified stream 522 for pH adjustment before discharge back to ocean.

The flow rates through the basified compartment 508 and acidified compartment 510 can be independently controlled to achieve target pH values in the acidified and basified compartments 508, 510, respectively. For example, the pH of the basified chamber can reach >14 to minimize the use of ocean water that needs to be processed via nano-filtration.

FIG. 6 is a schematic illustration of an exemplary electrodialysis system 600 for capturing CO₂ from ocean water, which system 600 uses the electrodialyzer 500 of FIG. 5. The system 600 includes a single-cell configuration of the electrodialyzer 500, an ocean water tank 618, and one or more liquid-gas membrane contactors 620 for removing CO₂ gas 622 from the acidified ocean water 630 output from the acidified compartment 510. Other embodiments of the system 600 may include multi-cell configurations of the electrodialyzer 500.

In operation, the basified output stream 520 may be fed back 617 into the NF ocean water 618 and/or combined with the discharged acidified stream 626 to adjust the pH down to usual levels found in the ocean. Hydrogen gas 616 may be stripped from the basified stream 520 and fed to the gas channel 514. NF ocean water 624 is provided as input to the basified compartment 508, while MF ocean water 628 is input to the acidified compartment 510.

In some embodiments, the M-CEMs 28, 32, 218, 220, 512, 608 may be commercially-available cation exchange membranes, such as Neosepta CMS, Selemion CSO, Fujifilm CEM Mono, PC MVK, or the like.

The ocean water received by the electrodialyzers 10, 200, 400, 500 and systems 100, 600 can be micro-filtered by being sent through multimedia filter (including disc filter and cartridge filter), followed by ultrafiltration. During these two steps, algae, organic particles, sand particles, smaller impurities and other particles are removed.

Although the figures show three membrane contactors in each membrane contactor 108, 110, 620, as an example, any suitable number of membrane contactors may be included in the membrane contactors 108, 110, 620 shown in FIGS. 2 and 6. For example, in some embodiments, the membrane contactors 108, 110, 620 may include one or two liquid gas contactors, whereas in other embodiments, tens or hundreds of membrane contactors may be included in each, or any suitable number in those ranges. The membrane contactors may commercially-available membrane contactors.

Each of the electrodialyzers 10, 200, 400, 500 disclosed herein may have any suitable number of cells. For example, in some embodiments, the electrodialyzer may have only one multi-compartment cell. In other embodiments, the electrodialyzer may have between two and ten cells in its stack. In other embodiments, electrodialyzer may have 10 s or 100 s of cells in its stack, or any suitable number therebetween.

In each of the electrodialyzers 10, 200, 400, 500 disclosed herein, the stream flow rates through the various compartments can be independently and selectively controlled to achieve target pH values and/or ion concentrations in the acidified and basified compartments, respectively.

The foregoing description is illustrative and not restrictive. Although certain exemplary embodiments have been described, other embodiments, combinations and modifications involving the invention will occur readily to those of ordinary skill in the art in view of the foregoing teachings. Therefore, this invention is to be limited only by the following claims, which cover at least some of the disclosed embodiments, as well as all other such embodiments, equivalents, and modifications when viewed in conjunction with the above specification and accompanying drawings.

What is claimed is:

1. An electrodialyzer, comprising:
one or more multi-compartment cells, each of the cells including:
a saltwater compartment;
a base compartment receiving a base solution stream; and
a bipolar membrane (BPM) separating the saltwater compartment and base compartment;
a catholyte compartment;
a first monovalent cation exchange membrane (M-CEM) separating the catholyte compartment and the saltwater compartment of one of the multi-compartment cells;
a cathode contacting the catholyte compartment;
an anolyte compartment;
a second M-CEM separating the anolyte compartment and the base compartment of one of the multi-compartment cells;
an anode contacting the anolyte compartment; and
one or more intermediate monovalent cation exchange membranes (M-CEMs)separating the multi-compartment cells, if there is more than one multi-compartment cell in the electrodialyzer.

2. The electrodialyzer of claim 1, wherein the electrodialyzer is used to remove carbon dioxide from ocean water.

3. The electrodialyzer of claim 1, wherein the saltwater compartment receives a stream of filtered ocean water.

4. The electrodialyzer of claim 1, wherein the base stream is NaOH.

5. The electrodialyzer of claim 1, wherein the catholyte compartment and the anolyte compartment each receive a recirculated electrolyte solution, respectively.

6. The electrodialyzer of claim 5, wherein the electrolyte solution includes a one-electron, electrochemically reversible redox couple.

7. The electrodialyzer of claim 6, wherein the one-electron, electrochemically reversible redox couple is selected from the group consisting of Na₃/Na₄—[Fe(CN)₆] and K₃/K₄—[Fe(CN)₆].

8. The electrodialyzer of claim 1, wherein each of the intermediate CEMs is configured to allow the transfer of monovalent cations from the saltwater compartment to the base compartment of an adjacent cell, while rejecting the transfer of anions and multivalent cations from the saltwater compartment to the base compartment in the adjacent cell.

9. The electrodialyzer of claim 1, wherein the BPM generates proton (H⁺) and hydroxide ion (OH⁻) fluxes via water dissociation reactions at a BPM interface, where the proton flux is provided to the saltwater compartment so as to convert an input saltwater stream to the saltwater compartment into an output stream of acidified saltwater, and the hydroxide ion is provided to the base compartment to increase the base concentration of the base stream received by the base compartment.

10. An electrodialyzer, comprising:
one or more multi-compartment cells, each of the cells including:
a first compartment;
a second compartment;
an anion exchange membrane (AEM) separating the first compartment and the second compartment;
a third compartment; and
a bipolar membrane (BPM) separating the second compartment and the third compartment;
a catholyte compartment;
a first monovalent cation exchange membrane (M-CEM) separating the catholyte compartment and the first compartment of one of the multi-compartment cells;
a cathode contacting the catholyte compartment;
an anolyte compartment;
a second M-CEM separating the anolyte compartment and the third compartment of one of the multi-compartment cells;
an anode contacting the anolyte compartment; and
one or more intermediate monovalent cation exchange membranes (M-CEMs)separating the multi-compartment cells, if there is more than one multi-compartment cell in the electrodialyzer.

11. The electrodialyzer of claim 10, wherein an output stream of the second compartment is input to the first compartment.

12. The electrodialyzer of claim 10, wherein the third compartment receives a base stream.

13. The electrodialyzer of claim 10, wherein the second compartment receives a stream of filtered ocean water.

14. The electrodialyzer of claim 10, wherein the first, second, and third compartments each receive a respective stream of filtered ocean water.

15. The electrodialyzer of claim 10, wherein the AEM allows the passage of anions from the first compartment to the second compartment and rejects the passage of cations between the first compartment and the second compartment.

16. The electrodialyzer of claim 10, wherein the catholyte compartment and the anolyte compartment each receive a recirculated electrolyte solution, respectively.

17. The electrodialyzer of claim 16, wherein the electrolyte solution includes a one-electron, electrochemically reversible redox couple.

18. The electrodialyzer of claim 17, wherein the one-electron, electrochemically reversible redox couple is selected from the group consisting of Na₃/Na₄—[Fe(CN)₆] and K₃/K₄—[Fe(CN)₆].

19. The electrodialyzer of claim 10, wherein the BPM generates proton (H⁺) and hydroxide ion (OH⁻) fluxes via water dissociation reactions at the BPM interface, where the proton flux is provided to the second compartment so as to convert an input saltwater stream to the second compartment into an output stream of acidified saltwater, and the hydroxide ion flux is provided to the third compartment to increase the base concentration of a stream received by the third compartment.

20. The electrodialyzer of claim 10, wherein each of the intermediate CEMs is configured to allow the transfer of monovalent cations from the first compartment to the third compartment of an adjacent cell, while rejecting the transfer of anions and multivalent cations from the first compartment to the third compartment in the adjacent cell.
